(19) United States
(12) Patent Application Publication
(10) Pub. No.: US 2016/0117637 A1
(43) Pub. Date: Apr. 28, 2016

(54) APPARATUS AND METHOD FOR TRACKING AND MANAGING CEMENT, CONCRETE, OR OTHER DELIVERIES

(71) Applicant: Martin Marietta, Inc., Raleigh, NC (US)

(72) Inventors: Terry Lee Marshall, Allen, TX (US); Leandro Emilio Fellin, Frisco, TX (US); Balasubramanian Venkataraman, Cary, NC (US)

(21) Appl. No.: 14/744,978

(22) Filed: Jun. 19, 2015

Related U.S. Application Data
(60) Provisional application No. 61/982,434, filed on Apr. 22, 2014.

(51) Int. Cl. G06Q 10/08; G01C 21/36; G01C 21/34; G06F 3/0481

(52) U.S. Cl. CPC G06Q 10/0832; G06Q 10/0833; G06Q 10/08355; G06F 3/0481; G01C 21/3667; G01C 21/3407

(57) ABSTRACT

A method implemented by an electronic device includes receiving information associated with an order of one or more time-sensitive orders for construction materials. The method also includes displaying, based on the information, a time when the order is to be delivered by, a current location of a vehicle associated with the order, and a total amount of construction material ordered and delivered for the order. An electronic device includes a controller configured to receive information associated with an order of one or more time-sensitive orders for construction materials. The electronic device also includes a display unit configured to display, based on the information, a time when the order is to be delivered by, a current location of a vehicle associated with the order, and a total amount of construction material ordered and delivered for the order. The method and electronic device are used to track and manage various deliveries.

### CROSS-REFERENCE TO RELATED APPLICATION AND PRIORITY CLAIM

This application claims priority under 35 U.S.C. §119(e) to U.S. Provisional Patent Application No. 61/982,434 filed on Apr. 22, 2014. This provisional patent application is hereby incorporated by reference in its entirety.

### TECHNICAL FIELD

This disclosure relates generally to tracking and management applications. More specifically, this disclosure relates to an apparatus and method for tracking and managing cement, concrete, or other deliveries.

### BACKGROUND

Concrete is routinely mixed at one location and transported to a construction site at another location for pouring. The time between mixing and pouring often needs to be small (such as about 90 minutes or less), or the concrete becomes unusable and cannot be used at the construction site.

### SUMMARY

This disclosure provides an apparatus and method for tracking and managing cement, concrete, or other deliveries. For example, an application is executed by a mobile device, a server, or another computing device. The application is used to track cement, concrete, or other shipments. The application is also used to redirect or reschedule shipments when needed and perform other actions related to shipments.

In a first embodiment, a method implemented by an electronic device is provided. The method includes receiving information associated with an order of one or more time-sensitive orders for construction materials. The method also includes displaying, based on the information, a time when the order is to be delivered by, a current location of a vehicle associated with the order, and a total amount of construction material ordered and delivered for the order.

In a second embodiment, an electronic device is provided. The electronic device includes a controller configured to receive information associated with an order of one or more time-sensitive orders for construction materials. The electronic device also includes a display unit configured to display, based on the information, a time when the order is to be delivered by, a current location of a vehicle associated with the order, and a total amount of construction material ordered and delivered for the order.

In a third embodiment, a non-transitory, computer-readable medium storing one or more executable instructions is provided. The one or more executable instructions, when executed by one or more processing devices, cause the one or more processing devices to control a reception of information associated with an order of one or more time-sensitive orders for construction materials. The one or more executable instructions, when executed by one or more processing devices, also cause the one or more processing devices to generate for display, based on the information, a time when the order is to be delivered by, a current location of a vehicle associated with the order, and a total amount of construction material ordered and delivered for the order.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting the use of a delivery tracking and management application for mobile devices or other devices according to this disclosure;

FIG. 2 illustrates an example device for use in the system 100 according to this disclosure; and

FIGS. 3 through 13 illustrate details of an example application for mobile devices and other devices according to this disclosure.

### DETAILED DESCRIPTION

The various figures discussed below and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

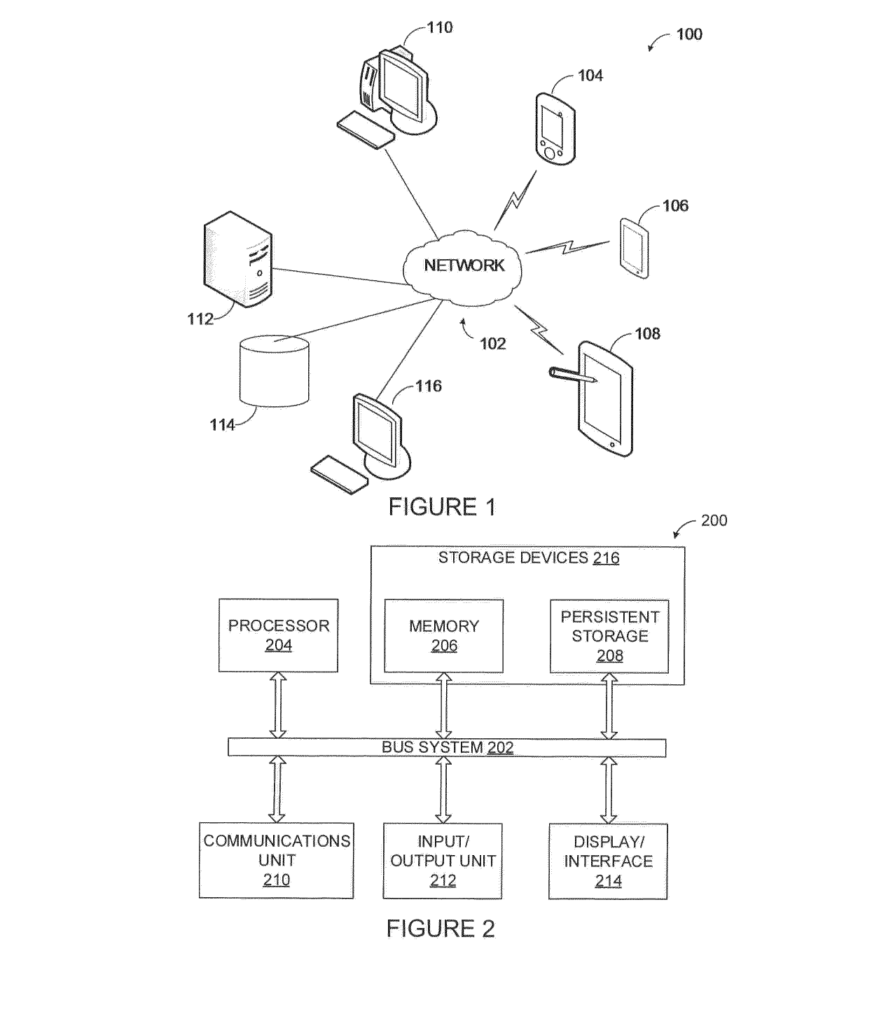

FIG. 1 illustrates an example system 100 supporting the use of a delivery tracking and management application for mobile devices or other devices according to this disclosure. As shown in FIG. 1, the system 100 includes a network 102. The network 102 generally represents a communication network or combination of communication networks facilitating communication between different devices or systems. Each network 102 provides any suitable communication links, such as wired, wireless, fiber optic links, or the like. In particular embodiments, the network 102 includes a combination of networks, such as the Internet, one or more cellular communication networks, and one or more local or wide area networks (which could support wired or wireless communications).

Multiple consumer or end user devices 104-110 communicate via the network 102. The user devices 104-110 generally denote devices used by consumers wishing to access information related to shipments of cement, concrete, or other construction materials (such as aggregate), where delivery of the shipments is time-sensitive. The user devices 104-110 include fixed or mobile devices that communicate over wired, wireless, or other connections with at least one of the networks 102.

In this example, the user devices 104-110 include a personal digital assistant 104, a smartphone 106, a tablet computer 108, and a desktop or laptop computer 110. Any other or additional user devices can be used in the system 100, and the system 100 can support interaction with any number of user devices.

One or more servers 112 also communicate over the network 102. Each server 112 represents a computing device that provides information about shipments of cement, concrete, or other construction materials (such as aggregate). Information associated with the operations of the server 112 is stored in a related database 114. For example, each server 112 retrieves and provides information about a company truck or other vehicles that are currently out to deliver cement, concrete, or other construction materials (such as aggregate), as well as information about past and future deliveries. Different information or additional information can also be provided by each server 112. Each server 112 includes any suitable structure for providing information and interacting with user devices. The database 114 includes any suitable structure for storing information and for facilitating retrieval of information.

One or more operator stations 116 are capable of interacting with an associated server 112. For example, an operator station 116 allows personnel of a company that provides cement, concrete, or other construction materials (such as aggregate) to enter information about past, current, or future shipments of construction materials (such as aggregate). Each operator station 116 includes any suitable structure supporting interaction with a server, such as a desktop computer, laptop computer, dumb terminal, or mobile device.

As described herein, each user device 104-110 executes an application or accesses an application executed by the server 112. The application allows a user to interact with and receive information from the server 112. For example, the server 112 receives requests from the user devices 104-110 and in response to receiving request from the user device 104-110 provides information from the database 114. Other operations supported by the application are described herein.

Although FIG. 1 illustrates one example of a system 100 supporting the use of a delivery tracking and management application for mobile devices or other devices, various changes may be made to FIG. 1. For example, FIG. 1 is intended as an example system that supports the use of a construction material tracking and management application and is not intended as an architectural limitation. Also, various components in FIG. 1 could be combined, further subdivided, rearranged, or omitted and additional components could be added according to particular needs.

FIG. 2 illustrates an example device 200 for use in the system 100 according to this disclosure. The device 200 can represent any of the components 104-112 and 116 in FIG. 1. In this example, the device 200 includes a bus system 202. The bus system 202 supports communication between a processing device 204, a memory 206, a persistent storage 208, a communications unit 210, an input/output (I/O) unit 212, and a display or display interface 214. Any suitable bus system(s) 202 can also be used here.

The processing device 204 processes software/firmware instructions, such as instructions loaded into the memory 206. The processing device 204 can include a single processor, multiple processors, one or more multi-processor cores, or other type(s) of processor(s) depending on the particular implementation. As an example, the processing device 204 is implemented using a number of heterogeneous processor systems in which a main processor is present with secondary processors on a single chip. As another example, the processing device 204 is a symmetric multi-processor system containing multiple processors of a same or similar type. Any suitable processing device(s) can be used.

The memory 206 and the persistent storage 208 are examples of storage devices 216. A storage device is any piece of hardware capable of storing information, such as data, program code, or other suitable information on a temporary or permanent basis. The memory 206 can be a random access memory or other volatile or non-volatile storage device(s). The persistent storage 208 contains one or more components or devices, such as a hard drive, flash memory, optical disc, or other persistent storage device(s). A storage device can be fixed or removable, such as when a removable hard drive or USB thumb drive is used.

The communications unit 210 provides for communications with other systems or devices. For example, the communications unit 210 includes a network interface card or a wireless transceiver. The communications unit 210 provides communications through physical or wireless communications links.

The I/O unit 212 allows for input and output of data using other components connected to or integrated within the device 200. For example, the I/O unit 212 provides a connection for user input through a keyboard, a mouse, a microphone, or another input device. The I/O unit 212 also sends output to a display, printer, speaker, or other output device. The I/O unit 212 alternatively includes a keyboard, a mouse, a speaker, a microphone, or another input or output device(s). If the device 200 includes a display 214, the display or display interface 214 provides a mechanism to visually present information to a user. In some user devices, the display is represented as a touchscreen.

Program code for an operating system, applications, or other programs is located in the storage devices 216, which are in communication with the processing device 204 through the bus system 202. Instructions forming the programs are loaded into the memory 206 for processing by the processing device 204.

Although FIG. 2 illustrates one example of a device 200 that is used in the system 100, various changes can be made to FIG. 2. For example, FIG. 2 is simply meant to illustrate possible components in one specific implementation. Each of the components 104-110, 116 in FIG. 1 could be implemented in other ways, such as other ways that incorporate one or more processing devices, one or more memory devices storing data and instructions that are used, generated, or collected by the processing device(s), and one or more interfaces for communicating over the network 102.

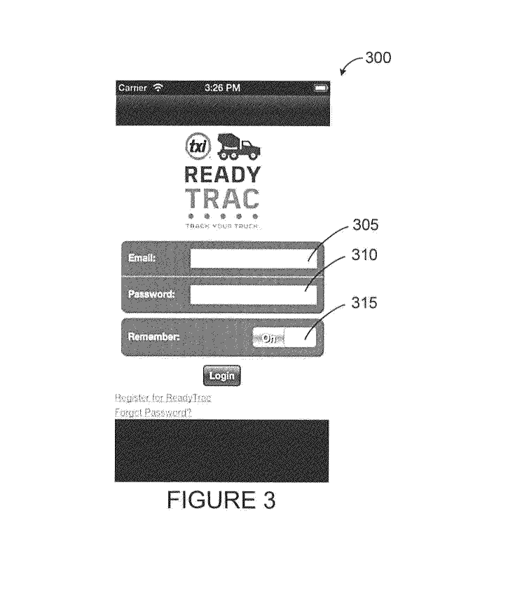

FIGS. 3 through 13 illustrate details of an example application for mobile devices and other devices according to this disclosure. More specifically, FIGS. 3 through 13 illustrate graphical user interfaces used by an application executed on a mobile device to perform various functions for a mobile device user. Note, however, that the application can be executed by any other suitable fixed or mobile device.

FIG. 3 illustrates an example interface 300 that allows a user to log into the application or the server 112 according to this disclosure. As shown in FIG. 3, an email address (or other username) can be received by an email field 305 and a password can be received in a password field 310. An option of “remembering” the login credentials (such as a username or password) for future logins can be activated by receiving a selection of a remember button 315 initiating an “remember” state. Note, however, that other authentication mechanisms can be used, and an option of “remembering” the login credentials may not be provided.

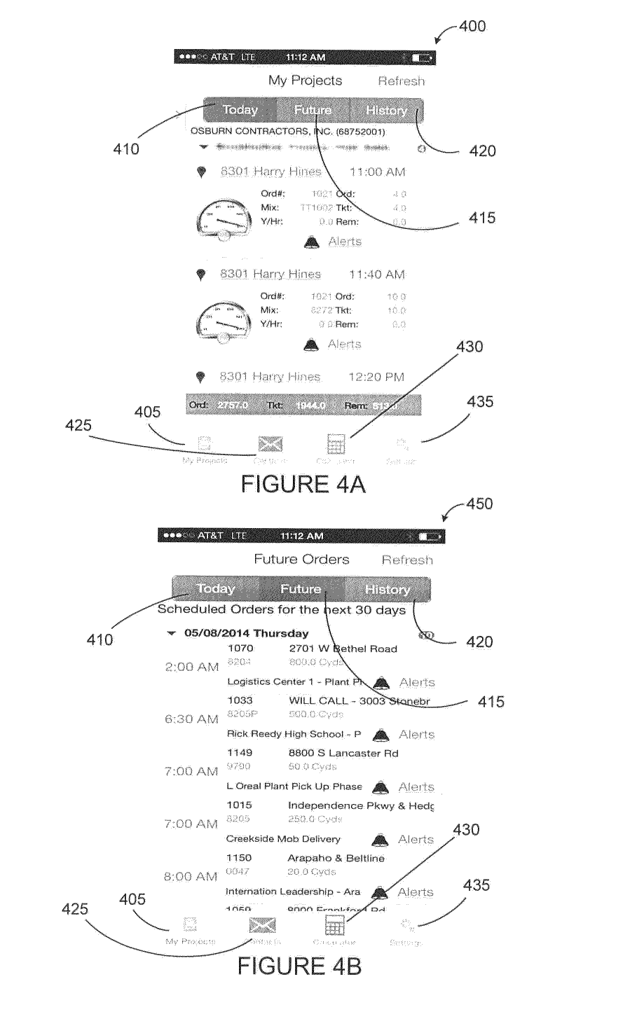

FIGS. 4A through 9 illustrate example interfaces that display information associated with orders for cement, concrete, or other construction materials (such as aggregate). The information shown in FIGS. 4A through 9 is retrieved from the server 112 after the user logs into the application or server 112 as shown in FIG. 3.

As shown in FIG. 4A, at the bottom of interface 400 a “My Projects” option 405 is selected. The interface 400 displays an option for viewing current orders 410 (such as order to be delivered today), an option for viewing future orders 415 (such as orders to be delivered in the next month), and an option for viewing historical orders 420 (such as orders that were delivered in the past week). In FIG. 4A, at interface 400, the option for viewing current orders 410 is selected and the orders being delivered today are displayed. For each order, the interface 400 in FIG. 4A provides an indication or displays the delivery location, the scheduled delivery time, the order number, and the type and quantity of material being delivered. Note that a similar interface 450 can be used to display future orders for the user when the option for viewing future orders 415 is selected as shown in FIG. 4B.

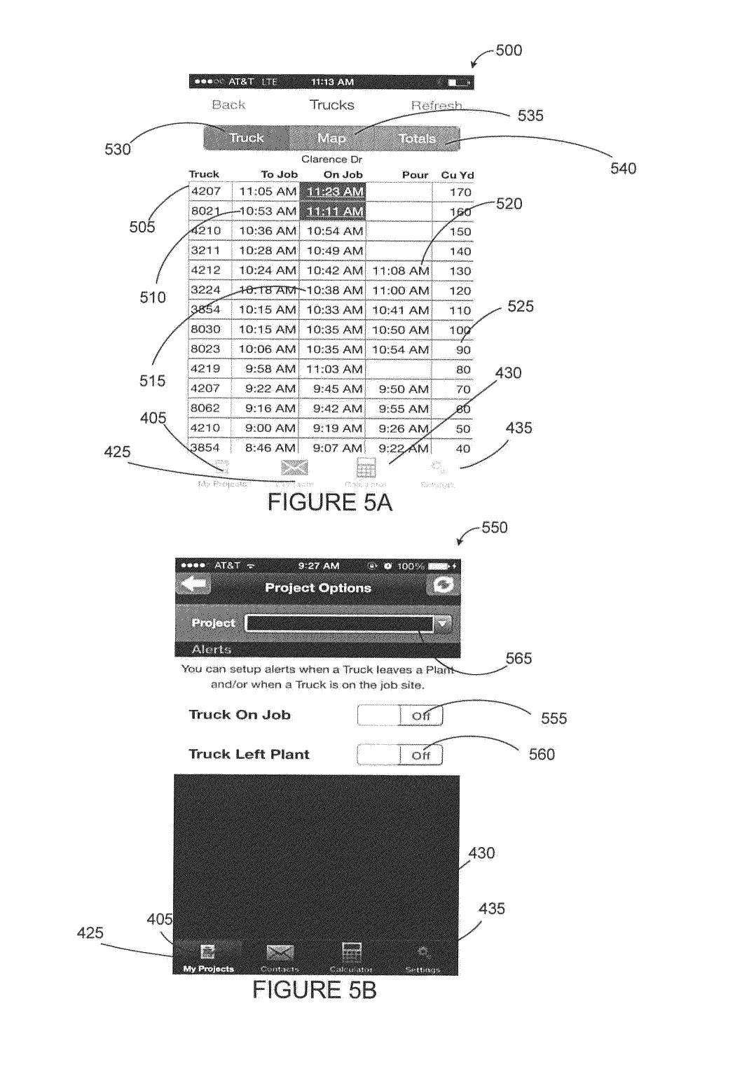

If a particular order is selected in FIG. 4A or 4B, the interface 500 shown in FIG. 5A can be presented. The interface 500 in FIG. 5A illustrates when a “truck” tab 530 is selected allowing for an identification, in a selected order, one or more trucks in a column of truck fields 505 that have made or are scheduled to make deliveries for a selected order. In this example, each truck is identified by a truck number indicated in a field of a column of “truck” fields 505. The interface 500 also identifies an actual or estimated time that each truck has left or will leave for a particular job site in a field of a column of “to job” fields 510. The interface 500 further identifies an actual or estimated time that each truck has arrived or will arrive at the particular job site in a field of a column of “on job” fields 515. The interface 500 identifies the actual time that a truck arrived at a pour location (if any) in a field of a column of “pour” fields 520 and an amount of material poured or to be poured in a field of a column of “Cu Yd” (cubic yards) fields 525.

The information shown in the interface 500 of FIG. 5A can be configured using the interface 550 shown in FIG. 5B. In FIG. 5B, using interface 550, controls are provided to control whether alerts are sent to and received by an electronic device of the user (such as push notifications) when a truck leaves a plant (where the truck is loaded with material) by activating or turning on a “truck on job” button 555 or when a truck arrives at a job site (where the truck delivers the material) by receiving an activating selection at a “truck left plant” button 560. A drop-down menu 565 at the top of the interface 550 is provided so that a selection of different projects can be received, allowing alerts to be customize on a per-project basis. Alerts are useful because they allow the users to receive notifications in a timely manner. This allows users to prepare to pour the materials being delivered or to identify potential problems with a delivery.

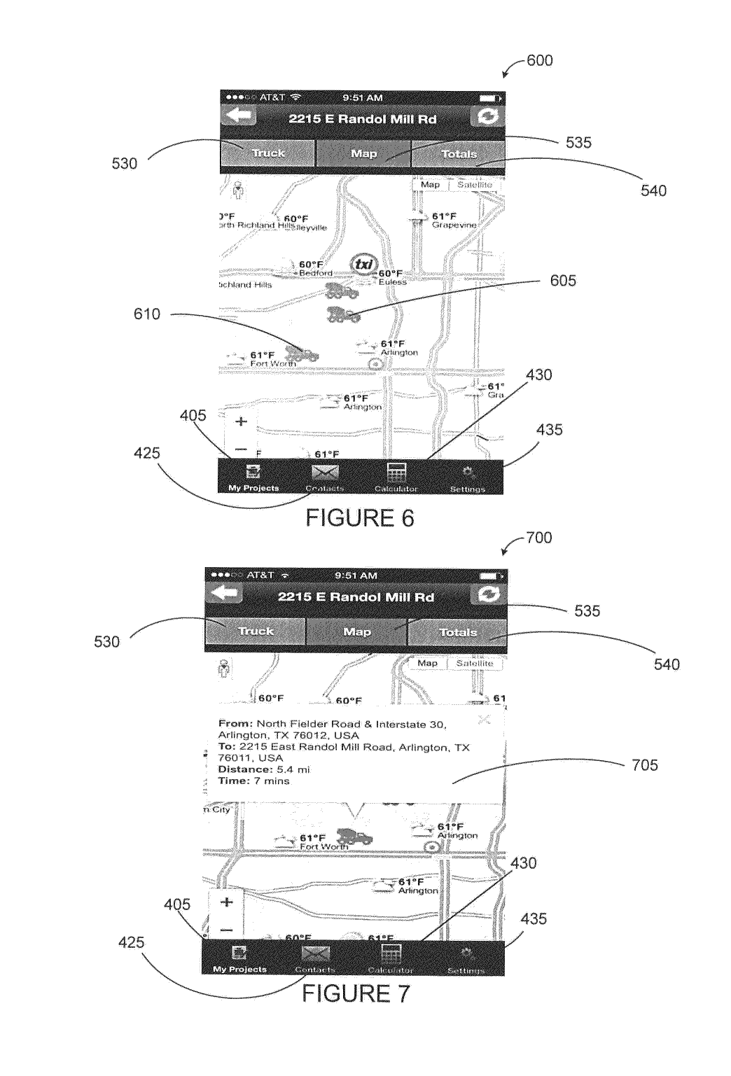

If a selection of a “Map” tab 535 in FIG. 5A is received, the interface 600 shown in FIG. 6 is presented. The interface 600 in FIG. 6 identifies the current geographical location(s) of the one or more trucks associated with the particular order on a map. The geographical location of a vehicle can be determined in any suitable manner, such as by using a GPS device on the vehicle (like a Trimble Navigation sensor). The delivery location where the trucks are heading to is also identified. If a selection of a particular truck (such as truck 605 or truck 610) in interface 600 of FIG. 6 is received, additional information 705 is displayed (such as in a balloon notification) as shown in interface 700 of FIG. 7. The additional information 705 shown in FIG. 7 identifies the selected truck's current location and destination, as well as the estimated distance from and estimated time of arrival at the job site.

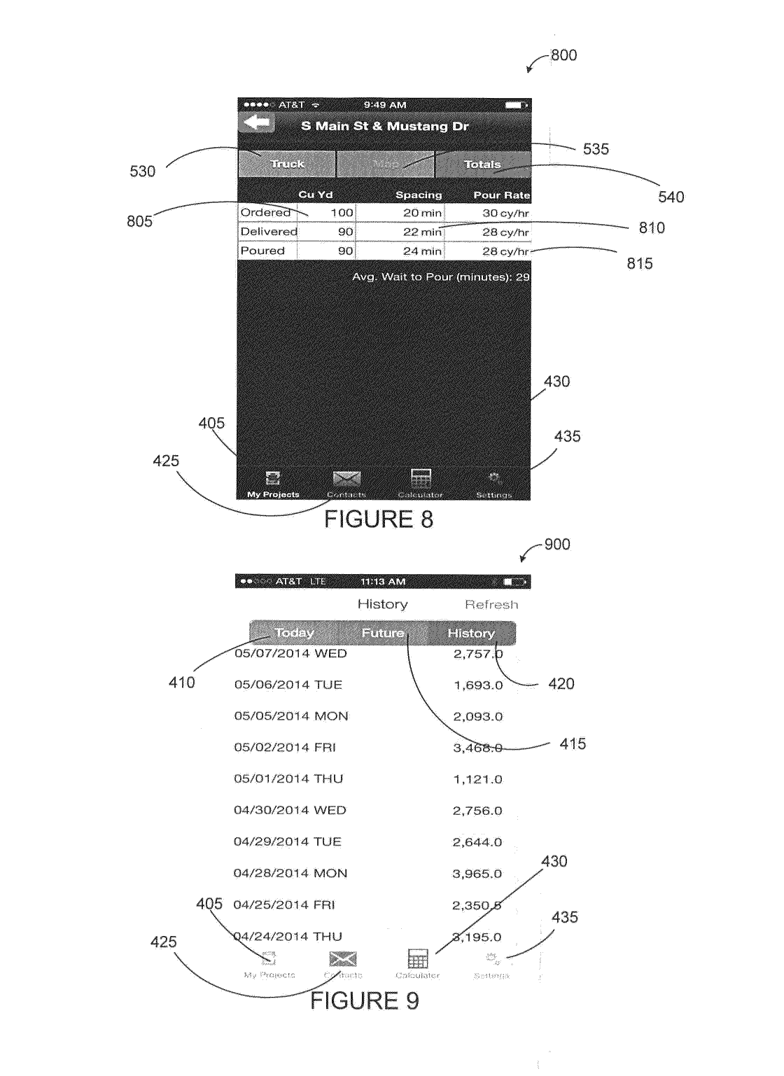

If a selection of a “Totals” tab 540 in FIG. 5A is received, interface 800 shown in FIG. 8 is presented. The interface 800 in FIG. 8 identifies, for a particular order, at column 805, how much material was ordered, how much material has been delivered to the job site, and how much material has been poured at the job site. The interface 800 in FIG. 8 also identifies, at column 810, the ordered spacings between deliveries/pours and the ordered pour rates, as well as the actual spacings between deliveries and pours and, at column 815, their associated pour rates.

If a selection of a “History” tab 420 in FIG. 4A or 4B is received, interface 900 shown in FIG. 9 is presented to the user. The interface 900 in FIG. 9 identifies historical deliveries made for the user. In this example, orders are grouped by day, and the total amount of material delivered each day is identified. Each day can be selected to view additional information about the order or orders delivered on that day. Note that a similar interface could be used to display “Future” orders for the user. That is, future orders could similarly be grouped by day, the total amount of material to be delivered each day could be shown, and each day could be selected to view the order or orders to be delivered on that day.

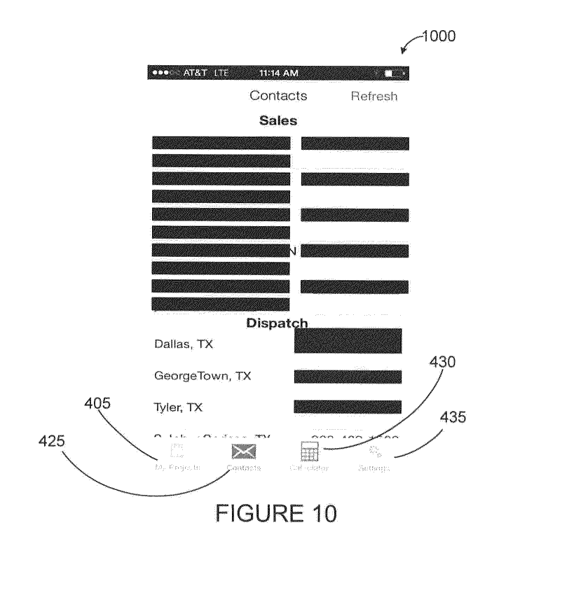

FIG. 10 illustrates an example interface 1000 that displays contact information. As shown in FIG. 10, at the bottom of interface 1000 the user has selected the “Contacts” tab 425. In FIG. 10, sales personnel can be identified by name and a telephone number or an email address can be provided for each person. Dispatch locations can also be identified, and a telephone number can be provided for each dispatch location. Note, however, that any other contact information or additional contact information can be provided for any suitable personnel, businesses, or other entities.

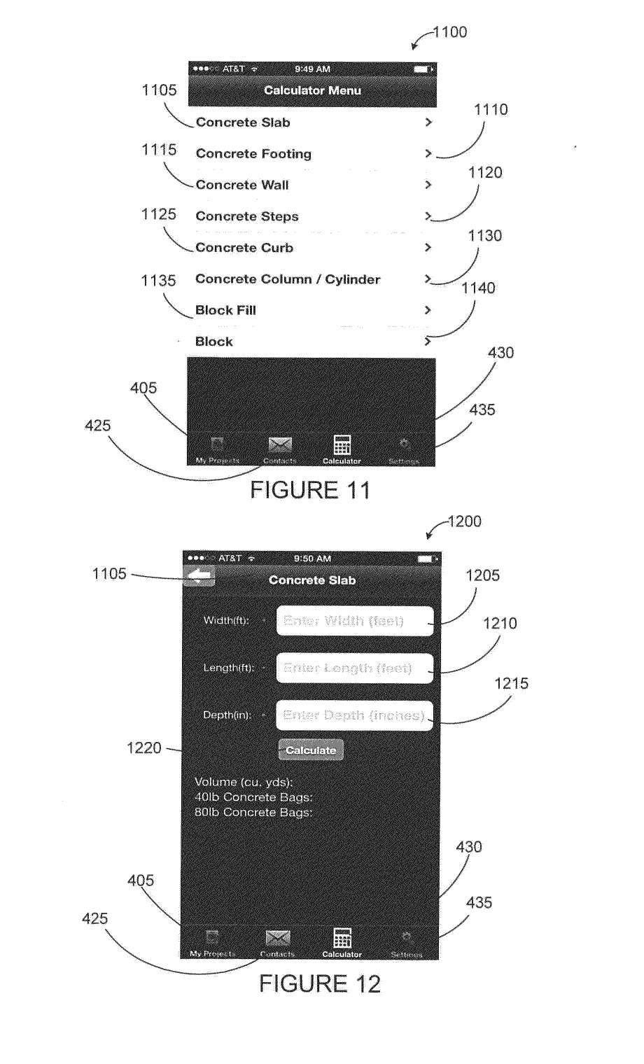

FIGS. 11 and 12 illustrate example interfaces 1100 and 1200, respectively, used to calculate amounts of cement, concrete, or other construction materials (such as aggregate) to be ordered. As shown in FIGS. 11 and 12, a “Calculator” tab 430 has been selected at the bottom of the interface.

In FIG. 11, on interface 1100, options 1105, 1110, 1115, 1120, 1125, 1130, 1135, and 1140 are displayed to calculate the amount of material (such as concrete) needed for different types of structures. Note that the specific structures shown herein are examples only and that any other or additional structures can be identified. In FIG. 12, on interface 1200, a “Concrete Slab” option 1105 from FIG. 11 is selected so that dimensions of the concrete slab can be entered in a width field 1205, a length field 1210, and a depth field 1215. Once the “Calculate” button 1220 is selected in FIG. 12, the interface 1200 presents the total volume of the structure, as well as a number of 40 pound bags and a number of 80 pound bags of concrete needed to form the structure. Of course, any other or additional information can be provided for the defined structure. The user can use the information from FIG. 12 in any suitable manner, such as to place an order for the identified amount of material.

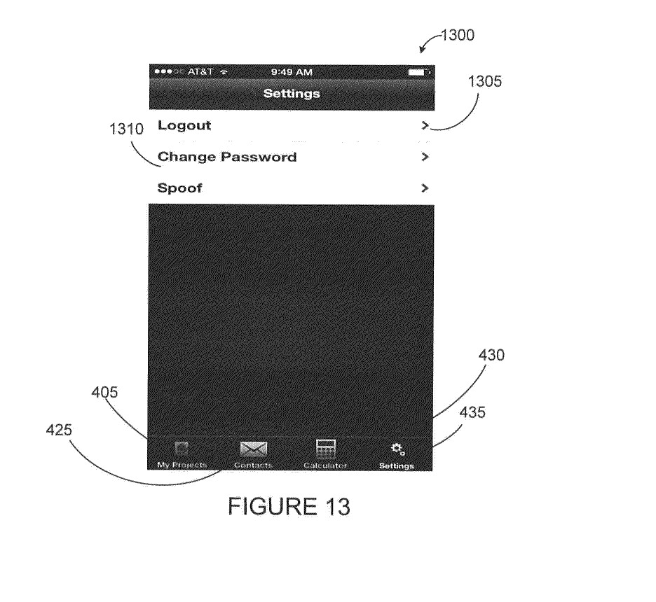

FIG. 13 illustrates an example interface 1300 according to this disclosure. As shown in FIG. 13, a “Settings” option 435 has received a selection at the bottom of the interface 1300. FIG. 13 illustrate an example interface 1300 allowing the user to invoke particular administrative functions of the application, such as logging out when a “logout” tab 1305 receives a selection or changing his or her password when a “change password” tab 1310 receives a selection.

Although FIGS. 3 through 13 illustrate details of one example of an application for mobile devices and other devices, various changes may be made to FIGS. 3 through 13. For example, while certain input/output mechanisms are shown here (such as text boxes, lists, and tables), any other suitable input/output mechanisms could be used to provide information to a user or receive information from a user. Also, the content and arrangement of information in these figures are for illustration only. The content and arrangement can be altered according to particular needs. In addition, other or additional interfaces could be used to support other or additional functions.

Note that a wide variety of other functions could be supported by the user devices or the application. For example, if a particular truck is selected as shown in FIG. 7, the user could be given the option of rerouting the truck from a first destination to a second destination. This could be useful, for example, if the truck cannot arrive in time at the first destination but could arrive in time at the second destination. Another truck could also possibly be rerouted to the first destination to compensate.

As another example, weather information could be superimposed on the map in FIGS. 7 and 8. The weather information could, for example, include radar images showing actual or anticipated rain or other precipitation for the given area. This information could be used to reroute trucks, delay deliveries, or otherwise take steps to avoid delivering material to one or more job sites where precipitation might interfere with pouring operations.

As yet other examples, an option could be provided for automatically placing an order for an amount of material calculated using the “Calculator” function. Similarly, an option could be provided for automatically re-ordering the same amount of material as a previous, current, or future order.

As still other examples, the application could allow a user in one location to view orders being delivered to or to be delivered to nearby job sites, such as within a specified radius of the user's current location (which could be user-defined).

As yet other examples, various business-related functions could be incorporated into or accessible via the application. Examples of business-related functions can include viewing, approving, or modifying invoices and invoice statuses; marking that goods or services have been received or provided; and supporting workflows for different tasks.

These examples are provided merely as additional functions that could be incorporated into the application described above. A wide variety of other functions could also be incorporated into the application.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method implemented by an electronic device, the method comprising:
receiving information associated with an order of one or more time-sensitive orders for construction materials; and
displaying, based on the information, a time when the order is to be delivered by, a current location of a vehicle associated with the order, and a total amount of construction material ordered and delivered for the order.

2. The method of claim 1, further comprising transmitting a new order for construction materials, and wherein receiving information associated with the one or more orders for construction information comprises receiving information associated with the new order.

3. The method of claim 2, wherein transmitting the new order for construction materials comprises transmitting at least one of a calculated amount of construction materials for the new order or a calculated number of construction material containers for the new order.

4. The method of claim 3, wherein the calculated amount of construction materials and the calculated number of construction material containers are based on dimensions of an object to be constructed.

5. The method of claim 1, wherein displaying the current location of the vehicle associated with the order comprises displaying the current location of the vehicle associated with the order on a map.

6. The method of claim 1, wherein the order is associated with a construction site location, and wherein when the current location of the vehicle is a route distance from the construction site location so that the vehicle is not capable of reaching the construction site location within a predetermined amount of time, transmitting a message to the vehicle to reroute to another construction site location that the vehicle is capable of reaching within the predetermined period of time.

7. The method of claim 6, further comprising identifying another vehicle that has a current location allowing the other vehicle to reach the construction site location within another predetermined amount of time.

8. The method of claim 1, further comprising receiving at least one of a notification that the vehicle reached a construction site location associated with the order or a notification that the vehicle has left a construction materials plant.

9. An electronic device comprising:
a controller configured to receive information associated with an order of one or more time-sensitive orders for construction materials; and
a display unit configured to display based on the information:
a time when the order is to be delivered by,
a current location of a vehicle associated with the order, and
a total amount of construction material ordered and delivered for the order.

10. The electronic device of claim 9, wherein the controller is configured to transmit a new order for construction materials, and wherein the received information associated with the one or more orders for construction information comprises information associated with the new order.

11. The electronic device of claim 10, wherein the controller is configured to calculate an amount of construction materials for the new order or a number of construction material containers for the new order.

12. The electronic device of claim 11, wherein the controller is configured to calculate the amount of construction materials and the number of construction material containers based on dimensions of an object to be constructed.

13. The electronic device of claim 9, wherein the display unit is configured to display the current location of the vehicle associated with the order on a map.

14. The electronic device of claim 9, wherein the order is associated with a construction site location, and wherein when the current location of the vehicle is a route distance from the construction site location so that the vehicle is not capable of reaching the construction site location within a predetermined amount of time, the controller is configured to transmit a message to the vehicle to reroute to another construction site location that the vehicle is capable of reaching within the predetermined period of time.

15. The electronic device of claim 14, wherein the controller is configured to identify another vehicle that has a current location allowing the other vehicle to reach the construction site location within another predetermined amount of time.

16. The electronic device of claim 9, wherein the controller is configured to receive at least one of a notification that the vehicle reached a construction site location associated with the order or a notification that the vehicle has left a construction materials plant.

17. A non-transitory, computer-readable medium storing one or more executable instructions that, when executed by one or more processing devices, cause the one or more processing devices to:
control a reception of information associated with an order of one or more time-sensitive orders for construction materials; and
generate for display based on the information:
a time when the order is to be delivered by,
a current location of a vehicle associated with the order, and
a total amount of construction material ordered and delivered for the order.

18. The non-transitory, computer-readable medium of claim 17, wherein when the one or more instructions are executed by the one or more processing devices, the one or more instructions also cause the one or more processing devices to transmit a new order for construction materials, and wherein the received information associated with the one or more orders for construction information comprises information associated with the new order.

19. The non-transitory, computer-readable medium of claim 17, wherein when the one or more instructions are executed by the one or more processing devices, the one or more instructions also cause the one or more processing devices to identify another vehicle that has a current location allowing the other vehicle to reach the construction site location within another predetermined amount of time.

20. The non-transitory, computer-readable medium of claim 19, wherein when the one or more instructions are executed by the one or more processing devices, the one or more instructions also cause the one or more processing devices to identify another vehicle that has a current location allowing the other vehicle to reach the construction site location within another predetermined amount of time.
